(19) United States
(12) Patent Application Publication
(10) Pub. No.: US 2022/0269954 A1
(43) Pub. Date: Aug. 25, 2022

(54) METHODS AND SYSTEMS TO APPLY DIGITAL INTERVENTIONS BASED ON MACHINE LEARNING MODEL OUTPUT

(71) Applicant: Deep Labs Inc., San Francisco, CA (US)

(72) Inventors: Theodore HARRIS, San Francisco, CA (US); Jiri NOVAK, Mill Valley, CA (US); Scott EDINGTON, Arlington, VA (US); Simon Robert Olov Nilsson, Seattle, WA (US); Talia BECK, Philadelphia, PA (US)

(21) Appl. No.: 17/677,996

(22) Filed: Feb. 22, 2022

Related U.S. Application Data
(60) Provisional application No. 63/151,944, filed on Feb. 22, 2021.

(51) Int. Cl. G06N 5/02; G06Q 20/40; G06F 40/143

(52) U.S. Cl. CPC G06N 5/022; G06Q 20/4016; G06F 40/143

(57) ABSTRACT

A system and a method for providing a digital intervention relating to user interactions. A system may have at least one processor configured to perform operations comprising: receiving input data from at least one client device; accessing a data model configured to determine, based on historical data, risk levels associated with the user interactions; inserting the input data into the data model; receiving, from the data model, an indication that at least one determined risk level associated with the user interactions exceeds a preset threshold; and providing, in response to the at least one determined risk level exceeding the preset threshold, the digital intervention.

### CROSS REFERENCE TO RELATED APPLICATIONS

This application claims the benefit of priority to U.S. Provisional Application No. 63/151,944 filed on Feb. 22, 2021, the content of which is herein incorporated by reference in its entirety.

### TECHNICAL FIELD

The present disclosure generally relates to fields of providing digital interventions based on machine learning analysis. For example, some disclosed techniques may include analyzing digital activity, such as web browser activity, using a machine learning model.

### BACKGROUND

Conventional techniques for monitoring digital activity often focus on few variables, do not understand relationships between variables, and fail to detect patterns for relevant feedback. For example, some systems may present an alert when a single particular variable is detected. However, these techniques fail to provide deeper analysis of digital behavior that could potentially produce more rapid or relevant feedback, which may benefit a user in real-time. For instance, some traditional responsive actions taken based on monitored digital activity may lack insight or appropriate timing. In some situations, analyzing data from a single device, user, or variable may present a myopic informational perspective.

Moreover, many actions taken in response to monitoring simply include a basic notification, which may be blocked by an application, may fail to receive a user's attention, or may otherwise fail to prevent a user from taking a specific action. Some conventional techniques may also avoid changing typical digital operations, such as web browser operations, which may further amplify these issues. Without performing more rigid, apparent, or digital-action-controlling actions, these techniques often fail to prevent the occurrence of an unintended or harmful digital activity (e.g., occurring within a web browser, such as an action dangerous to cyber security or financial resources).

### SUMMARY

Embodiments of the present disclosure may include technological improvements as solutions to one or more technical problems in conventional systems discussed herein as recognized by the inventors. In view of the foregoing, some embodiments discussed herein may provide systems and methods for providing a digital intervention relating to user interactions.

In one embodiment, a system includes at least one processor configured to perform operations comprising: receiving input data from at least one client device; accessing a data model configured to determine, based on historical data, risk levels associated with the user interactions; inserting the input data into the data model; receiving, from the data model, an indication that at least one determined risk level associated with the user interactions exceeds a preset threshold; and providing, in response to the at least one determined risk level exceeding the preset threshold, the digital intervention.

In accordance with some embodiments, real-time and targeted feedback may be provided in the form of digital interventions to a user with a goal of enhancing the user's experience relating to interactions with a digital platform, such as making an online purchase.

Further objects and advantages of the disclosed embodiments will be set forth in part in the following description, and in part will be apparent from the description, or may be learned by practice of the embodiments. Some objects and advantages of the disclosed embodiments may be realized and attained by the elements and combinations set forth in the claims. However, embodiments of the present disclosure are not necessarily required to achieve such exemplary objects or advantages, and some embodiments may not achieve any of the stated objects or advantages.

It is to be understood that both the foregoing general description and the following detailed description are exemplary and explanatory only and are not restrictive of the disclosed embodiments, as may be claimed.

### BRIEF DESCRIPTION OF DRAWINGS

FIG. 1 is a diagrammatic representation of a server for performing digital intervention operations, consistent with embodiments of the present disclosure.

FIG. 2 is a diagrammatic representation of a communications device, consistent with embodiments of the present disclosure.

FIG. 3 is a diagrammatic representation of a network for providing a digital intervention relating to user interactions, consistent with embodiments of the present disclosure.

FIG. 4A is a diagrammatic representation of a digital intervention applied in a graphical user interface, consistent with embodiments of the present disclosure.

FIG. 4B is a diagrammatic representation of a digital intervention integrated with a device, consistent with embodiments of the present disclosure.

FIG. 4C is a diagrammatic representation of a digital intervention integration, consistent with disclosed embodiments of the present disclosure.

FIG. 5 is a diagrammatic representation of a platform for providing digital intervention, consistent with disclosed embodiments of the present disclosure.

FIGS. 6A-6E are diagrammatic representations of a method for providing digital intervention, consistent with disclosed embodiments of the present disclosure.

FIG. 7 is a diagrammatic representation of a method for matching personas and determining a goal for providing digital intervention, consistent with disclosed embodiments of the present disclosure.

FIG. 8 is a diagrammatic representation of a method for identifying group candidates for providing digital intervention, consistent with disclosed embodiments of the present disclosure.

FIG. 9 is a diagrammatic representation of a method for advertisement and communication monitoring for providing digital intervention, consistent with disclosed embodiments of the present disclosure.

FIG. 10 is a diagrammatic representation of a method for normalizing and ingesting data for providing digital intervention, consistent with disclosed embodiments of the present disclosure.

FIG. 11 is a diagrammatic representation of a method for determining a goal and an action tree for providing digital intervention, consistent with disclosed embodiments of the present disclosure.

FIG. 12 is a diagrammatic representation of a method for determining outcome and stirring conversation for providing digital intervention, consistent with disclosed embodiments of the present disclosure.

FIG. 13 is a diagrammatic representation of a speech-to-text engine, consistent with disclosed embodiments of the present disclosure.

FIG. 14 is a diagrammatic representation of an action tree data structure, consistent with embodiments of the present disclosure.

FIG. 15 is a diagrammatic representation of a communication protocol for providing digital intervention, consistent with embodiments of the present disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to subject matter described herein.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

Machine learning (ML) and artificial intelligence (AI) based systems have streamlined user experiences on digital platforms. While streamlining the user experience may be beneficial in terms of convenience, it may present issues in terms of security risks, overconsumption, developing bad habits, and encouraging users to engage in unfavorable behaviors. The nature of digital platforms may encourage users to engage in activities that are not in the user's best interest, but instead are designed to maximize the benefits of another. For example, merchants may use ML-AI systems to target users susceptible to making certain kinds of purchases. Merchants may design the workflow, checkout procedure, and look-and-feel of a digital platform to make it easier for the user to make a purchase, although the user would probably not have made that purchase if given more opportunity to consider whether the purchase was necessary or prudent. The user may not be made aware of other important considerations, such as the fact that they will have insufficient funds in light of other upcoming obligations, but may be rushed into completing an operation on a digital platform.

Meanwhile, ML-AI systems have access to enormous amounts of data and computing resources that can be used to help guide users to reach more desirable outcomes. Consumers have grown accustomed to ML-AI systems monitoring their activities and aiding them in important decisions in some aspects, such as making recommendations for sleep habits, exercise, and other health-related issues. However, there remains a need for providing ML-AI systems to guide users in making informed decisions while interacting with digital platforms, especially in real-time as the user is using the digital platforms.

ML-AI systems may enable the use of large amounts of data stored in databases, data gathered in knowledge-bases, peer information, or data that is otherwise available, such as environmental information. ML-AI systems can quickly analyze massive amounts of data and can provide a user with useful feedback that may guide the user to reach desirable outcomes.

ML-AI systems may be employed to monitor users and may determine to provide digital interventions to users. Technology may track a user and the user's peer groups from their use of digital platforms (e.g., use of mobile devices), network information, or other information relating to the user or the user's environment. User information may be blended with environmental information (e.g., weather, news developments, market data, etc.) to provide rich signals for Al processing. An AI tier may use these signals to determine whether to provide a digital intervention to a user, and what kind of digital intervention may be beneficial to the user. A set of rules may be provided that can be used to create a targeted plan for a user that may disincentivize bad outcomes and incentivize good outcomes.

Digital interventions may impede a user's interactions with a digital platform. Digital interventions may include intelligent friction. Digital interventions may cause the user's interactions with the digital platform to be less seamless, but may improve the user's overall experience. Digital interventions may provide a deeper analysis of digital behavior, which can produce more rapid or relevant feedback. Digital interventions may offer users a benefit in real-time as they are interacting with a digital platform, such as a graphical user interface. Digital interventions may include digital-action-controlling actions. Such actions may be useful to prevent the occurrence of unintended or harmful digital activities (e.g., occurring within a web browser, such as an action dangerous to cyber security or financial resources).

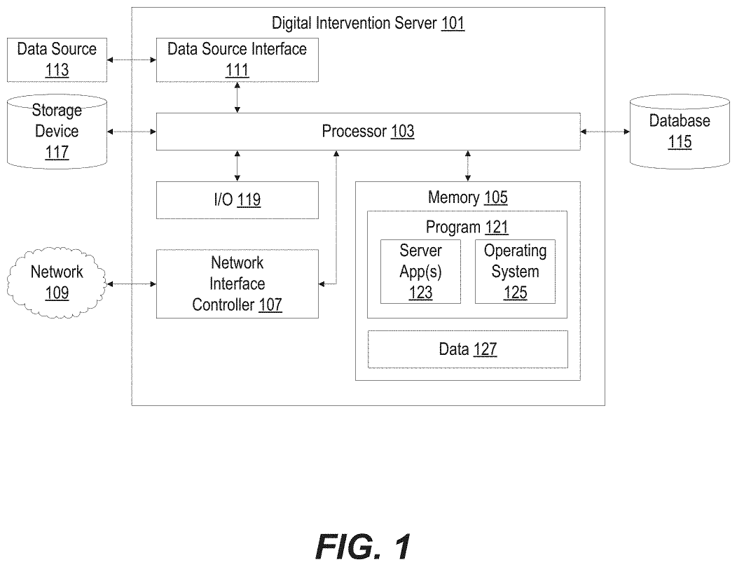

Reference is now made to FIG. 1, which illustrates a server for performing digital intervention operations, consistent with embodiments of the present disclosure. FIG. 1 shows a digital intervention server 101 which may include a processor 103, a memory 105, and a network interface controller 107. Processor 103 may include at least one processor configured to execute a program 121, applications, processes, methods, or other software to perform disclosed embodiments of the present disclosure. Processor 103 may be included in the device or system of the present disclosure and may include one or more circuits, microchips, microcontrollers, microprocessors, central processing unit, graphics processing unit, digital signal processor, or other suitable circuits for executing instructions. Processor 103 may include a single core or multi core arrangement. It is understood that other types of processor arrangements could be implemented.

Processor 103 may communicate with memory 105. Memory 105 may include data 127. Memory 105 may include any area where processor 103 or a computer stores or remembers data 127. A non-limiting example of memory 105 may include semiconductor memory. Semiconductor memory may either be volatile or non-volatile. Non-limiting examples of non-volatile memory may include flash memory, ROM, PROM, EPROM, and EEPROM memory. Non-limiting examples of volatile memory may include dynamic random-access memory (DRAM) and static random-access memory (SRAM).

Memory 105 may include program 121. Program 121 may refer to a sequence of instructions in any programming language that processor 103 may execute or interpret. Non-limiting examples of program 121 may include operating system 125, web browsers, office suites, or video games. Program 121 may include at least one of server application 123 and operating system 125. Server application 123 may refer to hardware or software that provides functionality for other programs 121 or devices. Non-limiting examples of provided functionality may include facilities for creating web applications and a server environment to run them. Non-limiting examples of server application 123 may include a web server, a server for static web pages and media, a server for implementing business logic, a server for mobile applications, a server for desktop applications, a server for integration with a different database, and any other similar server type. For example, server application 123 may include a web server connector, a computer programming language, runtime libraries, database connectors, or administration code. Operating system 125 may refer to software that manages hardware, software resources, and provides services for programs 121. Operating system 125 may load program 121 into memory 105 and start a process. Processor 103 may perform this process by fetching, decoding, and executing each machine instruction. Non-limiting examples of operating system 125 may include versions of Microsoft Windows, Apple's macOS, Chrome OS, and other similar systems.

Processor 103 may communicate with network interface controller 107. Network interface controller 107 may refer to hardware that connects a computer or processor 103 to a network 109. Non-limiting examples of network interface controller 107 may include network adapter, local area network (LAN) card, physical network interface card, ethernet controller, ethernet adapter, network controller, and connection card. Network interface controller 107 may be connected to network 109 wirelessly, by wire, by USB, or by fiber optics. Processor 103 may communicate with database 115. Database 115 may refer to a collection of data 127 stored and accessed electronically. Non-limiting examples of database 115 may include relational databases, NoSQL databases, cloud databases, columnar databases, wide column databases, object-oriented databases, key-value databases, hierarchical databases, document databases, graph databases, and other similar databases. Processor 103 may communicate with storage device 117. Storage device 117 may refer to any type of computing hardware that is used for storing, porting, or extracting data files and objects. Non-limiting examples of storage device 117 may include random access memory (RAM), read-only memory (ROM), floppy disks, and hard disks. Processor 103 may communicate with a data source interface 111. Data source interface 111 may communicate with a data source 113. Data source interface 111 may refer to a shared boundary across which two or more separate components of a computer system exchange information. A non-limiting example of data source interface 111 may include processor 103 exchanging information with data source 113. Data source 113 may refer to a location where data 127 is being used originates from. Processor 103 may communicate with an input or output 119. Input or output may refer to a transfer of data 127 between processor 103 and a peripheral device. Non-limiting examples of a transfer of data may include data 127 sent from processor 103 to the peripheral device or data sent from the peripheral device to processor 103.

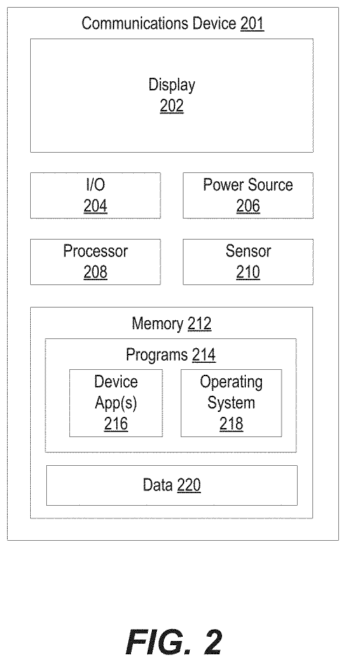

Reference is now made to FIG. 2, which illustrates a communications device, consistent with embodiments of the present disclosure. FIG. 2 shows a communications device 201. Communications device 201 may refer to any device, instrument, machine, equipment, or software that is capable of intercepting, transmitting, acquiring, decrypting, or receiving any sign, signal, writing, image, sound, or data in whole or in part. Non-limiting examples of communications device 201 may include a smartphone, a Wi-Fi device, a network card, a modem, an infrared device, a Bluetooth device, a laptop, a cell phone, a computer, an intercom, or a pager. FIG. 2 shows that communications device 201 may include a display 202. Display 202 may refer to an output surface and projecting mechanism that may show text, videos, or graphics. Non-limiting examples of display 202 may include a cathode ray tube (CRT), liquid crystal display (LCD), light-emitting diode, gas plasma, or other image projection technology. Communications device 201 may include an input/output unit 204, a processor 208, and a memory 212 as discussed herein. Memory 212 may include a program 214 and data 220 as discussed herein. Program 214 may include a device application 216. Device application 216 may refer to software installed or used on communications device 201, such as a data model (e.g., trained or untrained model) or an application interfacing with a data model. Program 214 may also include an operating system 218 as discussed herein. In some embodiments, data 220 may include input data (e.g., data configured as input for a data model).

Communications device 201 may include a power source 206. Power source 206 may refer to hardware that supplies power to communications device 201. A non-limiting example of power source 206 includes a battery. The battery may be a lithium-ion battery. Additionally, or alternatively, power source 206 may power communications device 201 and may be external to communications device 201. Communications device 201 may also include a sensor 210. Sensor 210 may include one or more sensors. The one or more sensors may include one or more image sensors, one or more motion sensors, one or more positioning sensors, one or more temperature sensors, one or more contact sensors, one or more proximity sensors, one or more eye tracking sensors, one or more electrical impedance sensors, or any other technology capable of sensing. For example, the image sensor may capture images or videos of a user or an environment. Non-limiting examples of the motion sensor may be an accelerometer, a gyroscope, and a magnetometer. Non-limiting examples of the positioning sensor may be a GPS, an outdoor positioning sensor, or an indoor positioning sensor. For example, the temperature sensor may measure the temperature of at least part of the environment or user. For example, the electrical impedance sensor may measure the electrical impedance of the user. Non-limiting examples of the eye-tracking sensor may include a gaze detector, optical trackers, electric potential trackers, video-based eye-trackers, infrared/near infrared sensors, passive light sensors, or other similar sensors.

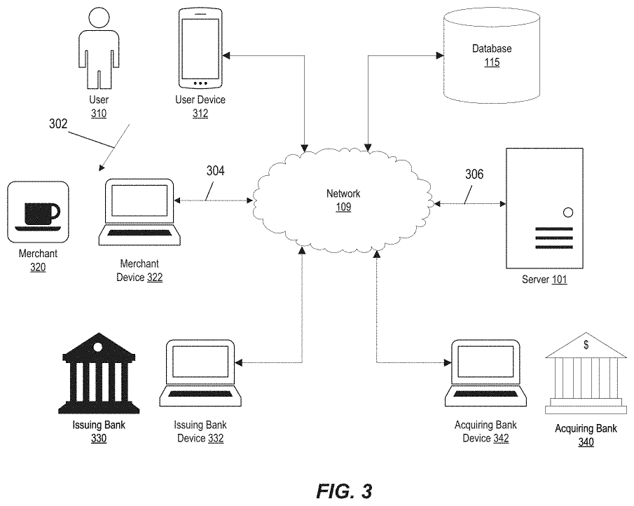

Reference is now made to FIG. 3, which illustrates a network for providing a digital intervention relating to user interactions, consistent with embodiments of the present disclosure. FIG. 3 shows a network 109. Network 109 may refer to a group or system of interconnected devices, programs, users, or associated processors. Network 109 may be connected to a user device 312. User device 312 may be associated with a user 310. User device 313 may refer to any device, instrument, object, machine, equipment, software, or similar apparatus adapted or used by user 310. Non-limiting examples of user device 313 may refer to a computer, a laptop, a cellphone, a smartphone, a tablet, a phone, or a camera.

User 310 and user device 312 have an association 302 with a merchant 320 and a merchant device 322. Association 302 may be physical or virtual. For example, association 302 may include user 320 using user device 312 virtually on a webpage of merchant 320. User device 312, through network 109, may be connected with merchant device 322 which allows user 310 to view or shop products offered by merchant 320.

Network 109 may also be connected to database 115 as described herein. Network 109 may also be connected to an issuing bank device 332. Issuing bank device 332 may be associated with an issuing bank 330. Issuing bank device 332 may refer to any device, instrument, object, or software associated or used by issuing bank 330. A non-limiting example of issuing bank device 332 may refer to a laptop or computer associated with or used by issuing bank 330. Issuing bank 330 may refer to a bank or financial institution that offers or issues credit or debit to a person. Issuing bank 330 may issue credit to user 310. Network 109 may also be connected to an acquiring bank device 342. Acquiring bank device 342 may refer to any device, instrument, object, or software associated or used by an acquiring bank 340. A non-limiting example of acquiring bank device 342 may refer to a laptop or computer associated with or used by acquiring bank 340. Acquiring bank device 342 may be associated with acquiring bank 340. Acquiring bank 340 may refer to a bank or financial institution that processes credit or debit payments on behalf of merchant 320. Acquiring bank 340 may receive funds on behalf of merchant 320. Network 109 may establish a connection 306 to digital intervention server 101 as described above. Connection 306 may be a client-server connection or peer-to-peer. Network 109 may also establish a connection 304 to merchant device 322. Merchant device 322 may be associated with merchant 320. Merchant device 322 may refer to a device, instrument, object, or software associated with or used by merchant 320. A non-limiting example of merchant device 322 may refer to a laptop or computer associated with or used by merchant 320. Merchant 320 may refer to a person or company who trades in commodities. Non-limiting examples of merchants 320 may refer to a wholesaler or a retail store owner. For example, network 109 may be connected to user device 312, database 115, merchant device 322, digital intervention server 101, issuing bank device 332, and acquiring bank device 342. Data associated with user device 312, database 115, merchant device 322, issuing bank device 332, and acquiring bank device 342 may be collected by server 101 or sent to server 101. Digital intervention server 101, through processor 103, may then process the acquired data 127. Digital intervention server 101 may then send data 127 back to network 109. Network 109 may then store data 127 in database 115 or relay data 127 back to user device 312, merchant device 322, issuing bank device 332, and acquiring bank device 342.

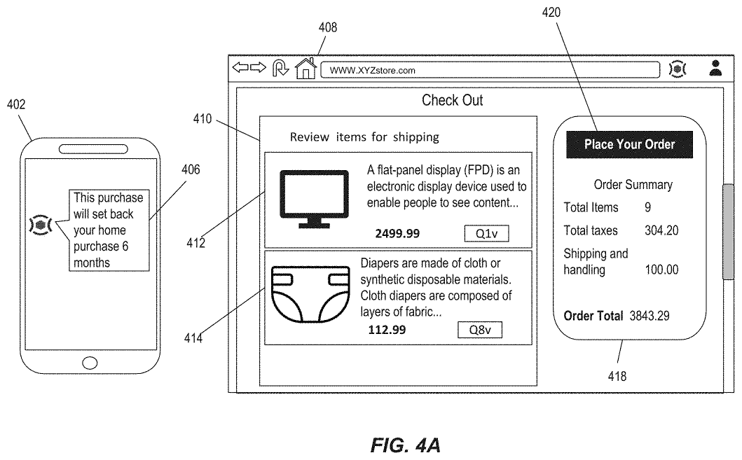

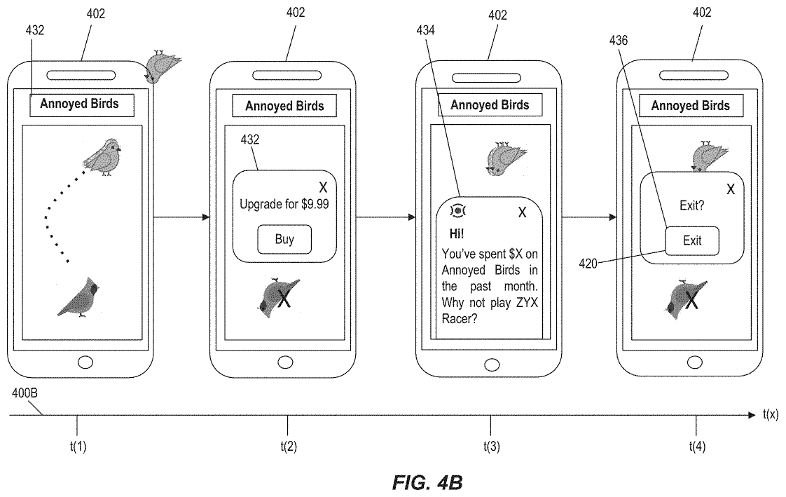

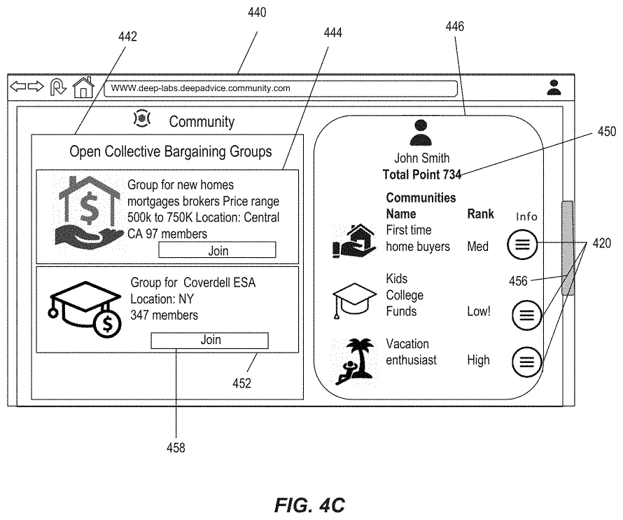

Reference is now made to FIG. 4A, which illustrates a digital intervention applied in a graphical user interface, consistent with disclosed embodiments of the present disclosure. FIG. 4A shows graphical user interface 408. Graphical user interface 408 may include display review 410. Display review 410 may be a display that includes at least one product. The at least one product may include an icon or picture of the product, a description of the product, the price of the product, a product identifier, reviews of the product, or any other relevant information related to the product. Display review 410 may include first product display 412. Display review 410 may also include second product display 414. Graphical user interface 408 may also include summary display 418. Summary display 418 may include information related to an order of products. The information may include the total number of products, total taxes, shipping and handling costs, and an order total. Summary display 418 may include button 420. Button 420 may refer to any graphical control element that provides user 310 a way to trigger an event. Non-limiting examples of button 420 may include a “Place Your Order” button 420.

FIG. 4A also shows communications device 402. Communications device 402 may include or be encompassed by a user device, such as user device 312 discussed above with reference to FIG. 3. Communications device 402 may display message 406. Message 406 may refer to any type of communication from communications device 402 to user 310. A non-limiting example of message 406 may be a text message (e.g., “This purchase will set back your home purchase 6 months.”). Message 406 may be received by user 310 while user 310 is checking out or before user 310 is checking out. For example, when user 310 attempts to check out, graphical display interface 408 may populate display review 410 and summary display 418. Display review 410 may populate first product display 412 and second product display 414. Summary display 418 may include “Place Your Order” button 420. When user 310 attempts to check out, “Place Your Order” button 420 is greyed or blocked out, preventing user 310 from confirming or placing the order. In some embodiments, communications device 402 receives message 406 once “Place Your Order” button 420 is greyed or blocked out. Alternatively, communications device 402 may receive message 406 simultaneously with “Place Your Order” button 420 becoming greyed or blocked out. User 310 may read message 406 (e.g., “This purchase will set back your home purchase 6 months.”) on communications device 402 and choose not to place order. Alternatively, user 310 may ignore message 406 and place order. In some embodiments, a notification may be overlaid on top of button 420 and may prevent button 420 from being pressed. Message 406 may be overlaid on button 420 so that user 310 is forced to read message 406 before proceeding.

Reference is now made to FIG. 4B, which illustrates an exemplary digital intervention integrated with a device, consistent with disclosed embodiments of the present disclosure. FIG. 4B shows communications device 402 at different time intervals 400B (t(1), t(2), t(3), and t(4)). For example, at time interval t(1), some embodiments may analyze user history related to application 430. One non-limiting example of application 430 may be a mobile phone videogame (e.g., “Annoyed Birds”). The analysis of user history related to application 430 may be performed by a processor associated with communications device 402. The analysis may indicate manipulation or influence from application 430 or historical data of application 430 in relation to user 310. For example, at time interval t(2), communications device 402 may receive notification 432. Non-limiting examples of notification 432 may include an attempted purchase notification, a push notification, a purchase notification, or any other similar notification (e.g., “Upgrade for $9.99”). For example, when user 310 tries to make a purchase in application 430, communications device 402 may display notification 432. In some embodiments, notification 432 may be analyzed to determine if notification 432 would cause user 310 to deviate from user's 310 goal. Additionally, or alternatively, notification 432 may be analyzed to determine if notification 432 was caused by application 430 manipulation or influence. For example, at time interval t(3), communications device 402 may display alert 434. Non-limiting examples of alert 434 may include haptic feedback, tactile feedback, an alarm, a sound, a song, or a notification (e.g., “Hi! You've spent $X on Annoyed Birds in the past month. Why not play ZYX Racer?”). For example, if disclosed embodiments determine notification 432 would cause user 310 to deviate from user's 310 goal or was caused by application 430 manipulation or influence, communications device 402 may display alert 434. For example, at time interval t(4), communications device 402 may display prompt 436. Prompt 436 may include button 420 (e.g., “Exit”).

Reference is now made to FIG. 4C, which illustrates an exemplary digital intervention integration, consistent with disclosed embodiments of the present disclosure. FIG. 4C shows graphical user interface 440. Graphical user interface 440 may include display plane 442. Display plane 442 may include information related to groups of users 310 in a community. A non-limiting example of display plane 442 may include information related to open collective bargaining groups. For example, disclosed embodiments may determine groups of users 310. Non-limiting examples of determined groups of users 310 may include users similar to one another, users not similar to one another, users in a family, users in a business, users in a relative geographical location, users with similar interests, users with non-similar interests, users in a college, high-performing users, low-performing users, average performing users, or any other logical grouping of users. Display plane 442 may include first display plane 444. First display plane 444 may be a first group of users 310. A non-limiting example of the first group of users 310 may be a group for new homes mortgages broker. For example, the group for new homes mortgages broker may include a price range of $500,000 to $700,000, a location at central California, and include 97 users. Advantageously, group for new homes mortgages broker may include high performing users who share similar goals. Users 310 in the group may help one another in gaining financial services (e.g., loans). Advantageously, risk is minimized for financial services providing loans which in turn enables financial services to provide lower cost services and include users 310 who, alone, may not been included. Display plane 442 may also include second display plane 452. Second display plane 442 may be a second group of users 310. A non-limiting example of the second group of users 310 may be a group for “Coverdell ESA.” The group may be located in New York and include 347 users 310. Advantageously, if user 310 does not meet requirements of the group, disclosed embodiments block or prevent user 310 from joining. In some embodiments, user 310 is provided information on how to meet requirements of the group.

Graphical user interface 440 may also include display profile 446. Display profile 446 may include information related to user 310. In some embodiments, the information may be based on historical purchasing information of user 310. Non-limiting examples of information included in display profile 446 may be the user's 310 picture or icon, the user's points 450, the user's 310 communities or groups, and information associated with the user's 310 communities or groups. Further, the name, rank, and other information related to user's 310 communities or groups may be provided. Non-limiting examples of rank may include low, medium, high, or bronze, silver, or gold. Non-limiting examples of communities or groups may include first time home buyers, kid college funds, and vacation enthusiast. Points 450 may be earned or gained by digital interventions. Points 450 may be spent or used to “buy” or enter into groups or communities. Advantageously, in some embodiments, display profile 446 may also include buttons 420. Buttons 420 may provide the user with detailed reports or information to guide user 310 to higher ranks and goals. Graphical user interface 440 may include scroll bar 456.

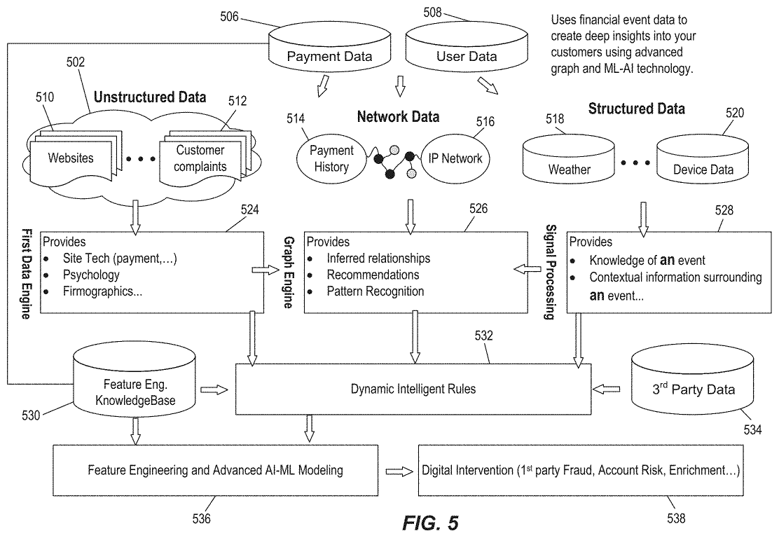

Reference is now made to FIG. 5, which is a diagrammatic representation of a platform for performing digital intervention operations, consistent with disclosed embodiments of the present disclosure. FIG. 5 shows user input data.

Non-limiting example of user input data may include data inputted by user 301, data related to a product, and payment data. For example, FIG. 5 provides user data 508 and payment data 506. In some embodiments, input data 508 and payment data 506 may be associated, transmitted, and/or grouped by a processor into unstructured data 502, network data, and structured data. Unstructured data 502 may refer to data that is not organized in a pre-defined manner, does not have a pre-defined data model, or any other similar non-organization. Structured data may refer to data that is organized in a pre-defined manner, does have a pre-defined data model, or any other similar organization.

Unstructured data 502 may include websites 510. Websites 510 may refer to a collection or singular web page and related content that is identified in a common domain name and published on at least one web server. Unstructured data 502 may also include customer complaints 512. Customer complaints 512 may refer to an expression by a person to a responsible party. Non-limiting examples of customer complaint 512 may be a positive customer review or a negative customer review. Unstructured data may be sent to or associated with first data engine 524. Data engine may refer to software used to create, read, update, and delete data from a database. Data from first data engine 524 may be sent to or associated with graph engine 526. Graph engine 526 may refer to a distributed, in-memory data processing engine. Additionally, or alternatively, data from first data engine 524 may be sent to or associated with dynamic intelligent rules 532. Dynamic intelligent rules 532 may refer to manipulating data to interpret information or data in a useful or predetermined way. A non-limiting example of dynamic intelligent rules 532 may include a dynamic intelligent recipe.

Structured data may include weather 518. Structured data may also include device data 520. Structured data may be associated with or sent to signal processing 528. Data from signal processing 528 may be sent to or associated with dynamic intelligent rules 532. Additionally, or alternatively, data from signal processing 528 may be sent to or associated with graph engine 526.

Network data may include payment history 514. Network data may also include IP network information 516. Data from graph engine 526 may be sent to or associated with dynamic intelligent rules 532.

Additionally, or alternatively, payment data 506 may be transmitted to knowledge base 530. Data from knowledge base 530 may be sent to or associated with feature engineering and advanced AWL modeling 536. Additionally, or alternatively, data from dynamic intelligent rules 532 may be sent to or associated with feature engineering and advanced AWL modeling 536. Dynamic intelligent rules 532 may also receive third party data 534. Data from feature engineering and advanced AWL modeling 536 may be sent to or associated with digital intervention 538.

Some disclosed embodiments may involve a computer-implemented system for providing a digital intervention relating to user interactions. In some embodiments, a single device, rather than system, may carry out the operations described herein. For example, at least one processing device (e.g., digital intervention server 101, communications device 201), may implement one or more of the steps discussed herein. Additionally, or alternatively, a computer-readable medium may include instructions, that when executed by at least one processor, perform the steps discussed herein.

In some embodiments, a server (or other device) may receive input data from at least one client device. Input data may include at least one of at least one of: metadata associated with a client device, web browser activity (e.g., viewing time spent on a webpage or website, time spent scrolling on a webpage, a user input at a webpage, or any other trackable action accomplished through a web browser), an API call (or other API operation), IP traffic (e.g., an IP address of a sender, an IP address of a recipient), a peripheral device input (e.g., a mouse click, a key press, a touchpad touch, a touchscreen touch), an electronic activity frequency (e.g., a frequency of a peripheral device input, webpage action, API), or an electronic activity pattern (e.g., a sequence or timing of digital activity, such as the various input data discussed herein). Additionally, or alternatively, the input data may include at least one of a psychological profile parameter, a demographic trait, a purchase item, a purchase amount, a product category, a merchant identifier, a merchant location, or a device location (e.g., indicating whether a device is within a predefined region). In some embodiments, determining (e.g., by a processor) whether a device's device location is within a predefined region may cause input data associated with the device to be considered. Input data may also include an electronic activity statistic, such as a mean, median, range, standard deviation, or any statistical value related to electronic activity or any type of input data. For example, an electronic activity statistic may include a standard deviation of how frequently a client device visits a website. A client device may be associated with a user or user-specific information, consistent with disclosed embodiments.

In some embodiments, input data may include at least one indication of a potential online purchase, such as a digital receipt number, a purchase confirmation number, an email message, HTML data associated with a purchase, or any other data associated with an online purchase influenced by (e.g., initiated by, performed by) a client device.

Input data may be sourced from one or more devices, such as a client device (e.g., a communications device 201). Referring to the embodiment depicted in FIG. 5, input data may be sourced from one or more entities, which may be devices, databases, systems, or other computing architectures for storing data. For example, input data may be sourced from or include unstructured data 502, which may include data from a website 510 (e.g., web data scraped, such as using a web crawler) or customer complaints 512. In some embodiments, input data may also be sourced from or include payment data 506 or User Data 508 (e.g., input by a user or client device). Consistent with disclosed embodiments, input data may also be sourced from or include payment history 514 or IP network 516 (e.g., may include IP network data, such as is discussed above). In some embodiments, input data may be sourced from or include structured data, such as weather data (e.g., forecasts, historical weather data) or device data (e.g., a current device location, a historical device location).

Some embodiments may involve accessing a data model, which may be configured to determine, generate, and/or compute risk levels (or one risk level) associated with the user interactions. A data model may include a machine-learning model, a statistical model, an artificial intelligence (Al) model, or any computerized program configured to determine a relationship associated with user interactions and a predicted result (e.g., a harmful online purchase). For example, a data model may include a neural network (e.g., a recurrent neural network, a convolutional neural network), an autoencoder, a word2vec model, a perceptron, a generative adversarial network, or any combination thereof. Referring to FIG. 5, a data model, device, or system may include multiple engines, modules, or components, such as intelligent trawler 524, graph engine 526, or signal processing 528 (e.g., a signal analysis module). These components may interpret different types of data (e.g., structured vs. unstructured data), reformat the data, interpret the data, or forward the interpreted data (or uninterpreted data) to dynamic intelligent recipes 532. In some embodiments, 3^{rd} party data 534 (e.g., data unrelated to a client device or data unobtainable from a public source) may also feed into dynamic intelligent recipes. Feature engine knowledgebase 530 may include historical data, versions of models, model parameters, or any other learned data that may influence a data model. In some embodiments, any combination of these components may feed data to feature engineering and advanced AWL modeling 536 (e.g., a data model).

In some embodiments, the data model may be configured to compute the risk levels (e.g., based on the input data, data model parameters, connections between neural network layers). In some embodiments, the data model may be trained to compute the risk levels based on training data sourced from the client device. Training data may include any aspect discussed with respect to input data. In some embodiments, training data may be sourced from multiple remote devices (e.g., client devices, such as communications device 201). In some embodiments, multiple remote devices may be associated with a peer group associated with a common trait, such as a common psychological profile parameter, a common demographic trait, a common purchase item, a purchase amount within a common threshold, a common product category, a common merchant identifier, a common merchant location, or a common region (e.g., device locations within a common predefined area, such as based on IP addresses or GPS coordinates). in some embodiments, a data model may be trained using only data from a specific set of sources (e.g., devices in a same peer group), and may be implemented for devices relating to those sources (e.g., client devices from the peer group). In some embodiments, the training data may include at least one of: web browser activity, an API call, IP traffic, a peripheral device input, an electronic activity frequency, or an electronic activity pattern, discussed above with respect to input data.

Accessing a data model may include generating the data model, training the data model, updating the data model (e.g., based on an additional round of training), modifying the data model, retrieving the data model (e.g., from a data structure, which may include multiple different data models tailored to produce different outputs) or receiving the data model. The data model may be configured to determine at least one risk level, which may be associated with at least one interaction. A risk level may include any quantification of a likelihood of an action (e.g., a probability of a digital activity, such as an online purchase). Determining at least one risk level may include analyzing one or more input data according to one or more model parameters. For example, a model may be trained (e.g., using training data, which may include training examples) using input datasets and corresponding results (e.g., digital actions related to the input datasets).

Some embodiments may include deploying the data model to the client device, where it may be run (e.g., instead of, or in addition to, being run at a server). For example, the data model may be configured to run on the client device, e.g., using at least one of Portable Format for Analytics (PFA) or Predictive Model Markup Language (PMML). In some embodiments, a data model may be trained at a server with higher processing capabilities than a client device, and may be deployed to one or more client devices to generate outputs (e.g., predictions, digital interventions), which may reduce strain on client devices while still providing them with useful outputs.

In some embodiments, the data model may be configured to determine the risk levels based on historical data. Historical data may include past data (e.g., input data, types of which are discussed herein) associated with (e.g., generated by, stored by) one or more client devices or other data sources (discussed above). For example, historical data may include web browser cookie data, financial account data, or digital online purchase confirmation information (e.g., shipping tracking data).

Some embodiments may include inserting the input data into the data model. Inserting the input data into the data model may include reformatting the input data (e.g., into a compatible format for the data model), standardizing the input data, initializing the data model with the input data, or performing any other operation to cause the data model to output a prediction based on the input data.

Some embodiments may include receiving (e.g., from the data model) an indication that at least one determined risk level associated with the user interaction exceeds a preset threshold. A preset threshold may include a static or dynamic value to which at least one determined risk level may be compared. For example, risk level or a preset threshold may include predictive information about a potential digital action, such as a likelihood (e.g., a probability) that a digital activity (e.g., an action taken within a web browser, such as with respect to a webpage will occur. A preset threshold may be determined by a user input, a machine input (e.g., a model output), or a combination of both. In some embodiments, a preset threshold may be updated over time (e.g., by a model) according to a history of user interactions (e.g., increasingly detrimental behavior, decreasingly detrimental behavior).

Some embodiments may include providing a digital intervention (e.g., in response to the at least one determined risk level). A digital intervention may include a prompt (e.g., a graphical user interface), HTML operation, command, rule, restriction, a data manipulation, an operation manipulation, or any other function to cause a change to browser or program functionality, or to prevent a digital action (e.g., an action within a browser). For example, the digital intervention may include instructions configured to inhibit (e.g., delay, disrupt, prevent, block) the user interactions (e.g., a digital activity, such as within a web browser), inhibit access to a webpage inhibit entry of user information (e.g., a credit card number, an address, a user identifier, or other value related to a user), or inhibit an API call (e.g., by manipulating content or structure of the API call, such as by misformatting an API call or removing an argument). In some embodiments, the digital intervention may include a two-factor authentication (2FA) prompt (e.g., which may be configured to prevent a digital activity from occurring until an expected 2FA value is entered into the prompt). By way of further example, a digital intervention may include removing, adding, or manipulating data within an API call or other instruction, causing an API, web browser, web page, HTML element, or other digital operation to not function as expected (e.g., to not function in a conventional way), such as by inhibiting a computerized operation, which may be related to an online purchase (e.g., implemented through a webpage). In some embodiments, a digital intervention may be generated and/or implemented by parsing and/or detecting an input (e.g., an HTML command at a webpage, an API call), comparing the input to a set of blocked input (e.g., API calls), and removing and/or misformatting the input (e.g., removing the HTML command, rendering an API call inoperable), such that the input will not function as intended (e.g., in a conventional way). In some embodiments, performing an inhibition (as discussed herein) may delay, disrupt, or prevent completion of a potential online purchase. Referring to FIG. 5, a customized deliverable 538, which may include a digital intervention may be output by (e.g., generated by) feature engineering and advanced AWL modeling 536. In some embodiments, customized deliverable may include a conversational agent (e.g., a chat bot) that is provided to guide the user.

In some embodiments, the data model may be configured to generate a suggestion relating to a potential online purchase (e.g., within a user interface). The digital intervention may include a notification containing at least one suggestion relating to the user interactions (e.g., generated by the data model). The notification may be displayed or otherwise indicated (e.g., through haptic feedback, audio) at a client device). In some embodiments, the notification may be provided periodically in a report (or other representation) to a client device. In some embodiments, the notification may be provided in real-time (e.g., while user interactions continue to occur). In some embodiments, the notification may be provided (e.g., displayed) within a web browser, such as within a web page or as a graphical user interface (GUI) or other indicator displayed onto of a web page. For example, the notification may be overlaid over at least a portion of a webpage associated with inputting information for a potential online purchase. By way of further example, a notification may be overlaid over a portion of a webpage associated with completing an online purchase, but without obscuring other information (e.g., purchase details in another portion of the webpage). This may allow a client device, such as a client device with limited screen space, to display a digital intervention (e.g., notification), while still conveying additional relevant information.

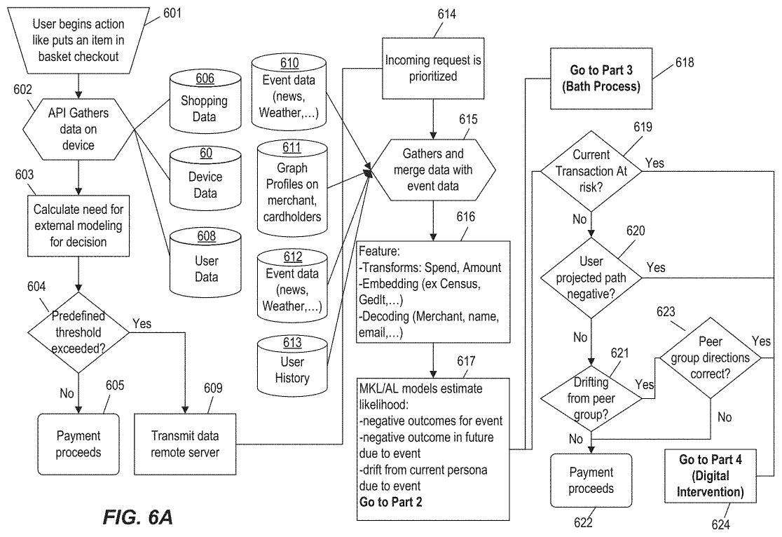

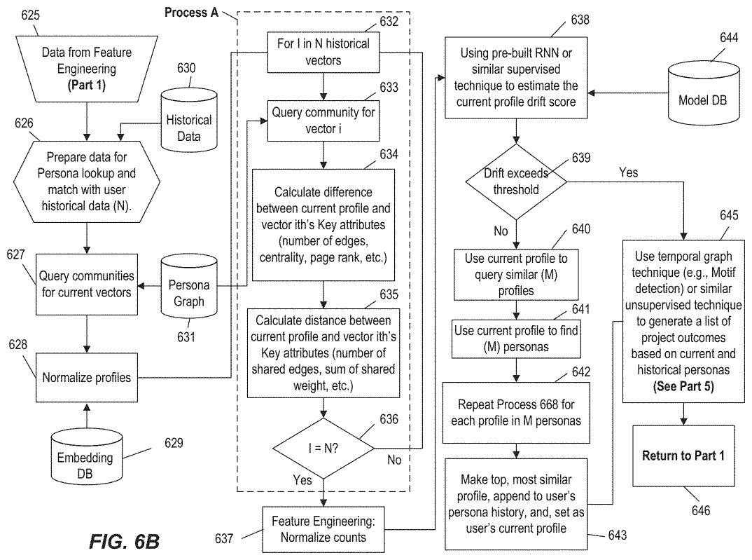

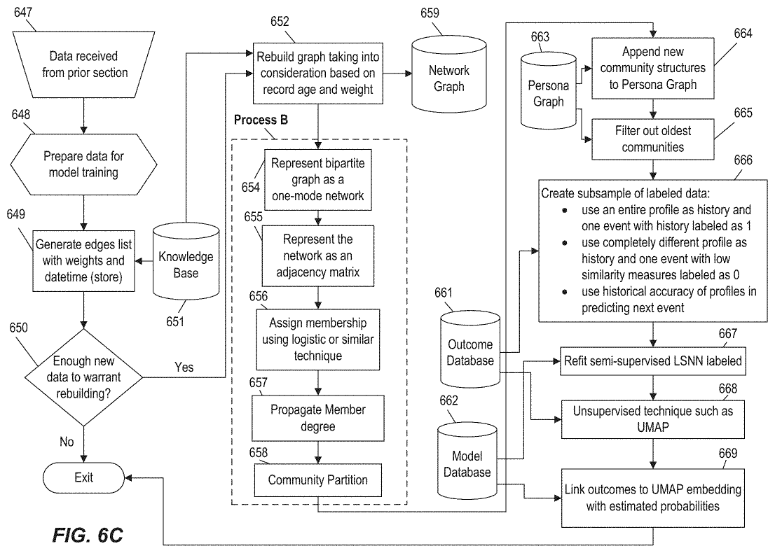

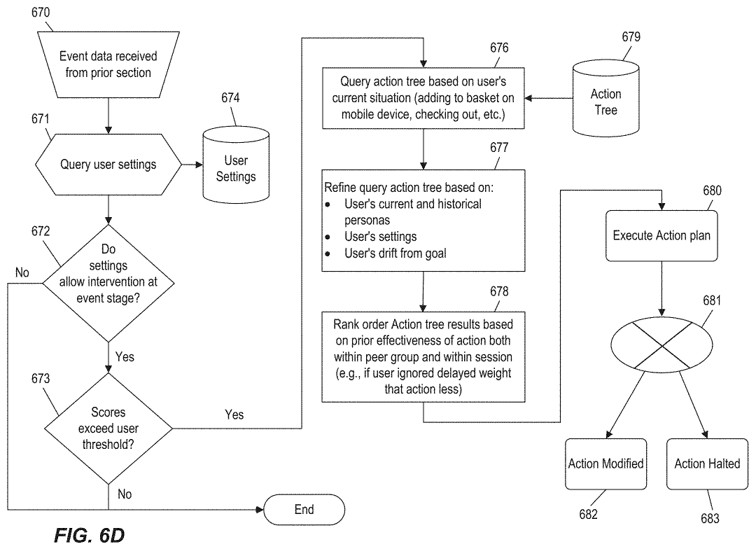

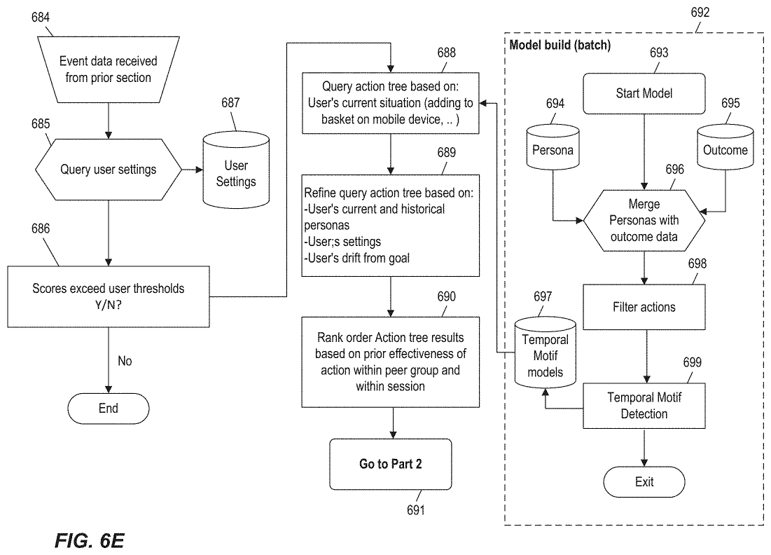

Referring to FIG. 6A, a schematic diagram, in some embodiments may be implemented as a computer system for providing feedback regarding purchase decisions. For example, the user may begin an action 601, which may be placing an item in a basket or checking out. At 602 the API gathers data on the device, which may include collecting shopping data 606, Device data 607, and user data 608. A calculation may be completed that determines the need for external modeling for a decision 603. The system may determine if a predefined threshold is exceeded 604. If there is no predefined threshold exceeded, then the payment may proceed 605. If it is determined that a predefined threshold is exceeded, then the system may transmit data to a remoter server 609. The incoming request is then prioritized 614. The system then gathers and merges data with event data 615, the data may include: event data 610, 612, which may include, for example, news and/or weather graph profiles on merchants and cardholders 611, and User History 613, for example. The system then considers features 616, where it transforms embeds and decodes data. The system then creates models and estimates which may show the likelihood of negative outcomes for future events 617, the likelihood of negative outcomes in the future due to events, and the likelihood of drift from the current persona due to an event. The system may then concurrently proceed to the bath process 618, and also determine if a current transaction is at risk 619. If a current transaction is at risk, then the system may proceed to digital intervention 624. If the user projected path is not at risk, then the system may then determine if the user projected path is negative 620. If the user projected path is negative, then the system may proceed to digital intervention 624. If the user projected path 624 is determined to not be negative, then the system will determine if there is drifting from peer group. If there is drifting from a peer group, then the system determines if the peer group directions are correct 623. If there is no drifting from a peer group, then payment proceeds 622. If the peer group directions are correct 623 then the system proceeds to digital intervention 624. If the peer group directions are not correct, then payment proceeds 622.

Referring to FIG. 6B, a method of matching persona and projecting, and using subgraph similarity to match profile to predict future actions is provided. The method of FIG. 6B, in some embodiments, may be implemented as a computer system for providing feedback regarding purchase decisions. For example, feature engineering data 625 and historical data 630 are combined and prepared for personal lookup and matched with user historical data (N) 626. Communities are then queered for current vectors 627 and profiles may be normalized 628, embedding DB 629. In some embodiments, communities may be combined with persona graph data 631 stored in a database before running a query for current vectors 627. The system may normalize profiles for I in N historical vectors 632 and calculate a difference between a current profile and chosen vector key attributes 634, which may include a number of edges, centrality, page rank, etc. In some embodiments, the system may query a community for vector i 633 and then calculate the distance between a current profile and the chosen vectors key attributes 635 which may include a number of shared edges, sum of shared weight, etc. The system may then determine whether normalized profiles for I are equal to N historical vectors at 636. If the normalized profiles for I are equal to N historical vectors at 636, the system may proceed to 637, at which the system may normalize counts via feature engineering. On the other hand, if the normalized profiles for I are not equal to N historical vectors at 636, the system may proceed to 638, at which the system may use pre-built RNN or similar supervised technique to estimate the current profile drift score. In some embodiments, at 638, the system may obtain pre-built RNN or similar supervised technique from a model database 644 to estimate the current profile drift score. The system may then determine whether the drift score estimated exceeds a predetermined threshold at 639. If the drift score exceeds the predetermined threshold, the system may proceed to 645, at which the system may use temporal graph technique (e.g., Motif detection) or similar unsupervised technique to generate a list of project outcomes based on current and historical personas. If the drift score does not exceed the predetermined threshold, the system may proceed to 640, at which the system may use current profile to query similar (M) profiles. The system may also use current profile to find (M) personas at 641. At 642, the system may repeat steps 632-636 for each profile in M personas and determine the top, most similar profile, append the top, most similar profile to the user's persona history, and set the top, most similar profile as the user's current profile. Using the top, most similar profile that is set as the user's current profile, the system may proceed to 645 at which the system may use temporal graph technique (e.g.,

Motif detection) or similar unsupervised technique to generate a list of project outcomes based on current and historical personas. Afterwards, at 646, the system may return to step 625.

Referring to FIG. 6C, a method of continuous updating of personas may be provided. The method of FIG. 6C may, in some embodiments, be implemented as a computer system for providing feedback regarding purchase decisions. At step 647, the system may receive data from the method of FIG. 6B. The system may then proceed to step 648, at which the system may prepare data for model training. At step 649, the system may generate a list of edges with weights and datetime and store the list in a knowledge database 651. At step 650, the system may determine whether there is enough new data to warrant rebuilding. If there isn't enough new data to warrant rebuilding, the system may exit the method of FIG. 6C. On the other hand, if there is enough new data to warrant rebuilding, the system may proceed to method 652, at which the system may rebuild a graph that takes into consideration the record age and weight. The system may store the rebuilt graph in network graph database 659. At step 654, the system may represent a bipartite graph as a one-mode network and at step 655, the system may represent the network as an adjacency matrix. Thereafter, the system may proceed to step 656, at which the system may assign membership using logistic or similar technique. At step 657, the system may propagate member degree and at step 658, the system may partition a community. At step 664, the system may obtain one or more persona graphs from persona graph database 663 and append new community structures to the one or more persona graphs. In addition, the system may filter out the oldest communities at step 665. At step 666, the system may create a subsample of labeled data, which may include using an entire profile as history and one event with history labeled as 1, using completely different profile as history and one event with low similarity measures labeled as 0, or using historical accuracy of profiles in predicting the next event. The predicted next event may be stored in outcome database 661. At steps 667 and step 668, the system may refit a semi-supervised LSNN stored and obtained from model database 662 and unsupervised technique stored in outcome database 661, such as UMAP, respectively. The system may link outcomes to UMAP via embedding with estimated probabilities at step 669 and store linked UMAP in model database 662.

Referring now to FIG. 6D, a method of creating and executing an adaptable digital intervention is provided. The method of FIG. 6D may, in some embodiments, be implemented as a computer system for providing feedback regarding purchase decisions. At step 670, the system may receive event data from the method of FIG. 6C and query user settings at step 671. The user setting may be stored in user settings database 674. At step 672, the system may determine whether the user settings allow intervention at an event stage. If the user settings do not allow intervention, the system may proceed to end the method of FIG. 6D. On the other hand, if the user settings allow intervention, the system may proceed to step 673, at which the system may determine whether the scores exceed a user threshold. If the scores do not exceed the user threshold, the system may proceed to end the method of FIG. 6D. If the scores exceed the user threshold, the system may proceed to step 676, at which the system may query an action tree based on the user's current situation (e.g., adding to basket on mobile device, checking out, etc.). The action tree may be stored in and obtained from an action tree database 679. In some embodiments, the system may proceed to step 677, at which the system may refine a query action tree based on, for example, the user's current and historical personas, user's settings, or user's drift from a goal. At step 678, the system may rank in order the action tree results based on prior effectiveness of an action both within the peer group and within the session (e.g., weight an action less if the user ignored or delayed). Based at least in part on the ranked action tree results, the system may proceed to step 680, at which the system may execute an action plan. Based on the executed action plan, the system may proceed to step 681, at which the system decides whether to modify the action at 682 or halt the action at 683.

Referring now to FIG. 6E, a method of projecting future actions using historic and inferred behavior trees is provided. The method of FIG. 6E may, in some embodiments, be implemented as a computer-implemented system for providing feedback regarding purchase decisions. For example, at step 684, the system may receive event data from the method of FIG. 6D. The system may then query user settings at step 685 and store the user settings in a user settings database 687. The system may proceed to step 686, at which the system determines whether the scores exceed one or more user thresholds. If the scores do not exceed the one or more user thresholds, the system may proceed to end the method of FIG. 6E. If the scores exceed the one or more user thresholds, the system may proceed to step 688, at which the system may query an action tree based on the user's current situation (e.g., adding to basket on mobile device, checking out, etc.). In some embodiments, the system may proceed to step 689, at which the system may refine a query action tree based on, for example, the user's current and historical personas, user's settings, or user's drift from a goal. At step 690, the system may rank in order the action tree results based on prior effectiveness of an action both within the peer group and within the session (e.g., weight an action less if the user ignored or delayed). In some embodiments, the system may use a batch framework at 692 to build a temporal motif model. For example, at step 696, the system may combine one or more personas obtained from persona database 694 and outcome data obtained from outcome database 695 with a starting model 693. The system may then filter the actions at step 698 and detect a temporal motif model at step 699. The detected temporal motif model may then be stored in a temporal motif model database 697. In some embodiments, one or more temporal motif models stored in database 697 may be used to query the action tree based on the user's current situation at step 688.

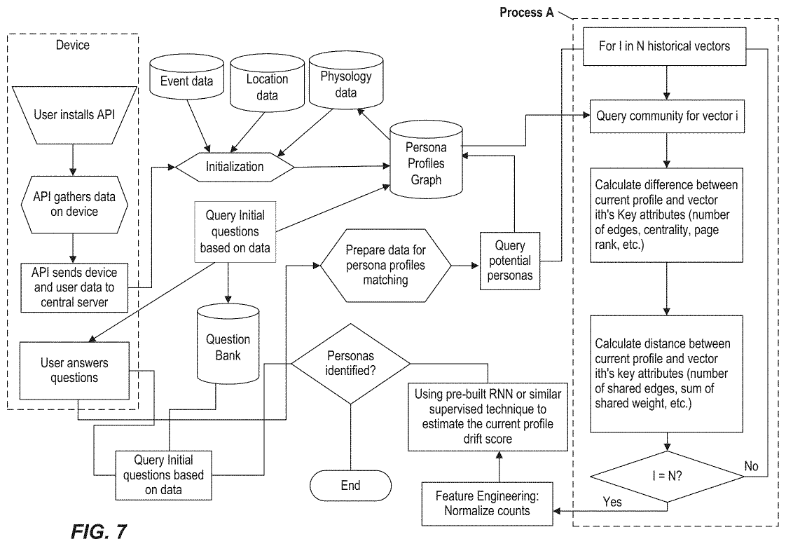

FIG. 7 illustrates an example method of matching one or more personas and determining a goal. The method of FIG. 7 may, in some embodiments, be implemented as a computer-implemented system for providing feedback regarding purchase decisions. Initially, the user may install on the user device an application programming interface (API) related to a software application program, for example, for making purchases. The API may gather data on the user device, such as information related to the user's purchase activity or purchase history, the user's search history, the user's financial account information, the type of user device, or the like. The API may send device data and/or user data that it collected to a central server. The API may also store device data and/or user data in a database. In some embodiments, in order to collect data on the user device, the user may be prompted to answer one or more questions. In some embodiments, the system may query initial questions for the user to answer based on data that the API gathered. In other embodiments, the system may obtain initial questions from a question bank database and prompt the user on the user device to answer the questions. In some embodiments, the system may query initial questions using a combination of one or more additional data, such as event data, location data, and physiology data. As an initialization step, the system may combine one or more of event data, location data, and physiology data to not only query initial questions for the user to answer, but also to determine one or more persona profiles associated with the user. The one or more persona profiles associated with the user may be stored in a database. In some embodiments, the one or more persona profiles may comprise user demographic profiles (e.g., age, gender, location) linked to eventual personas.

In some embodiments, the system may obtain device data and/or user data, including the user's answers to initial questions, and prepare the obtained data for persona profiles matching. For example, the system may identify one or more personas based on the obtained data. The system may query potential personas from the database storing one or more persona profiles and begin matching persona profiles. For example, the system may perform steps 632-636 of the method of FIG. 6B. As discussed above, the system may normalize profiles for I in N historical vectors and calculate a difference between a current persona profile and chosen vector key attributes, which may include a number of edges, centrality, page rank, etc. In some embodiments, the system may query a community for vector i and then calculate the distance between the current persona profile and the chosen vectors key attributes which may include a number of shared edges, sum of shared weight, etc. The system may then determine whether normalized profiles for I are equal to N historical vectors. If the normalized profiles for I are equal to N historical vectors, the system may normalize counts via feature engineering. On the other hand, if the normalized profiles for I are not equal to N historical vectors, the system may repeat steps 632-636 of the method of FIG. 6B and begin with normalizing profiles for I in N historical vectors again. In some embodiments, after normalizing counts via feature engineering, the system may use a pre-built RNN or a similar supervised technique to estimate the current profile drift score.

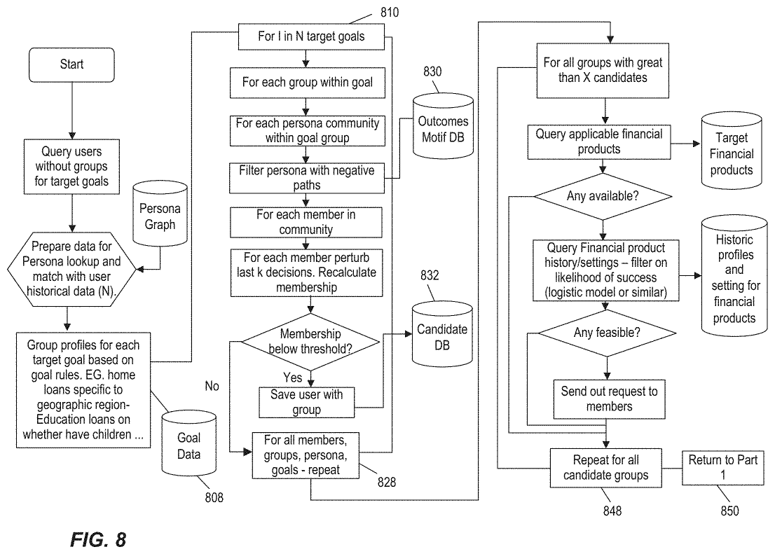

FIG. 8 illustrates an example method of identifying group candidates by looking for stable or emergent users within a persona group that may have high quality behavior patterns. The method of FIG. 8 may, in some embodiments, be implemented as a computer-implemented system for providing feedback regarding purchase decisions. For example, the system may query one or more users without groups for target goals and prepare data for persona lookup and match with the user's historical data (N). Data for persona lookup may be obtained from a persona graph database. The system may then group profiles for each target goal based on goal rules. Goal rules may comprise, for example, home loans specific to a geographic region, education loans, whether the user has any children, or the like. Target goals associated with the user may be stored in and obtained from a goal database 808. The system may normalize profiles for I in N target goals for each group within a goal and for each persona community within a goal group. The system may also filter persona with negative paths for each member in a community. The system may recalculate membership for each member perturb last k decisions. If the calculated membership is below a threshold, the system may save the user with the group and store the information in a candidate database. If the calculated membership is not below the threshold, the system may repeat the normalizing steps for all members, groups, persona, goals, etc. For all groups with greater than X candidates, the system may query applicable financial products and store the financial products in a target financial products database. If there are any financial products available, the system may query the financial product history and/or settings and filter based on likelihood of success (e.g., using a logistic model or the like). Historic profiles and settings for financial products may be stored in a database. If there are any feasible historic profiles and/or settings for financial products, the system may send out a request to the members and repeat the steps for all candidate groups.

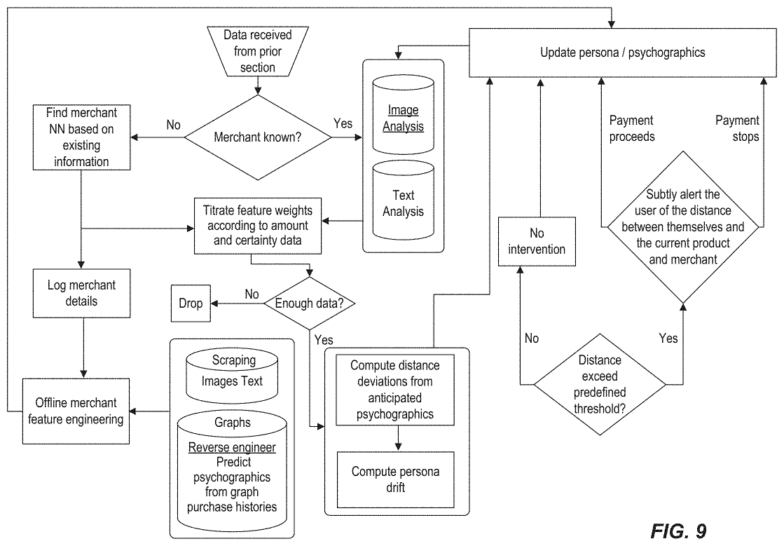

FIG. 9 illustrates an example method of monitoring advertisements and communications. In some embodiments, the method of FIG. 9 may be implemented as a computer-implemented system for providing feedback regarding purchase decisions. For example, the system may receive data and determine whether a merchant is known. If the merchant is not known, the system may find the merchant's NN based on existing information and log the merchant's details. Additionally, or alternatively, the system may titrate feature weights according to the amount and certainty data. In some embodiments, the system may use offline merchant feature engineering to update persona and/or psychographics. The system may acquire scraping images text data from the database and/or graphs stored in the database to perform offline merchant feature engineering. Graphs may be reverse engineered, for example, to predict psychographics from graph purchase histories. In other embodiments, if the merchant is known, the system may perform image analysis and text analysis to titrate feature weights according to amount and certainty data. Based on the titrated feature weights, the system may determine whether there is enough data. If there is insufficient data, the system may drop the method. Alternatively, if there is enough data, the system may computer distance deviations from anticipated psychographics and compute persona drift. The computed persona drift may be used to update persona and/or psychographics. In some embodiments, if the computed distance deviations exceed a predefined threshold, the system may subtly alert the user of the distance between themselves and the current product and merchant. The system may then decide whether to proceed with the payment or stop the payment. On the other hand, if the computed distance does not exceed the predefined threshold, the system may not perform any intervention.

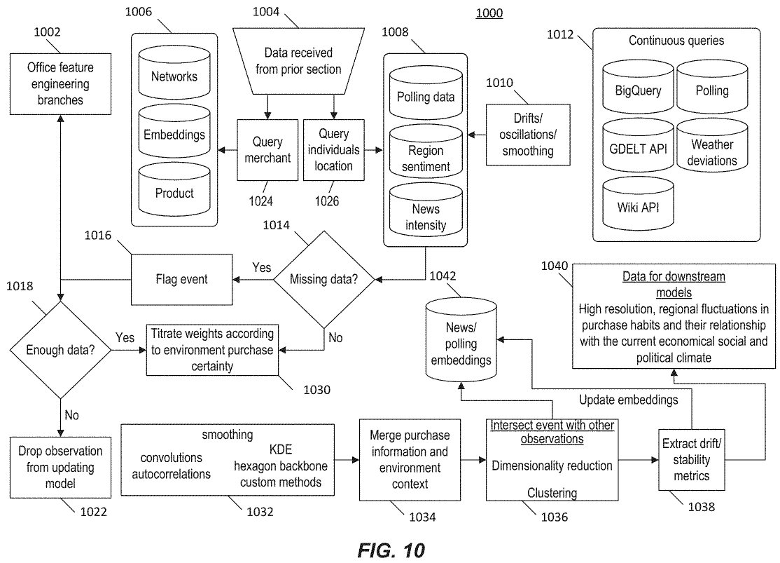

Reference is now made to FIG. 10, which illustrates a process for performing digital intervention operations, consistent with embodiments of the present disclosure. FIG. 10 shows process 1000 for performing digital intervention operations. Process 1000 may include first data structure 1006, second data structure 1008, continuous queries 1012, and data received from prior selection 1004. Drifts, oscillations, and/or smoothing 1010 may be include in process 1000. Office feature engineering branches 1002 may also be included in process 1000. First data structure 1006 may include networks, embeddings, and/or product. Second data structure 1008 polling data, region sentiment, news intensity. Data associated with drafts, oscillations, and/or smoothing 1010 may be sent to second data structure 1008. Data received from prior selection 1004 may be sent to query merchant 1024 and/or query individuals location 1026. Data from query merchant 1024 may be sent to first data structure 1006. Data from query individuals location 1026 may be sent to second data structure 1008. Data from second data structure 1008 may be sent to a checker 1014. Checker 1014 may check to determine if there is any missing data. If checker 1014 determines there is missing data, flagger 1016 will flag the event. Data from flagger 1016 may then be sent to different checker 1018 to determine if there is enough data. If different checker 1018 determines there is not enough data, data from different checker 1018 will be dropped from observation from updating model 1022. If different checker 1018 determines there is enough data, titrate weights 1030 may be applied according to environment purchase certainty. Data from flagger may also be sent to office feature engineering branches 1002. If checker 1014 determines there is no missing data, titrate weights 1030 may be applied according to environment purchase certainty.

Process 1000 may include smoothing 1032 of data which may include convolutions, autocorrelations, KDE, hexagon backbone, and/or custom methods. Data from smoothing 1032 may be sent to merge 1034 where the data from smoothing 1032 merges purchase information and environment context. Data from merge 1034 may then be sent to intersect event 1036. Intersect 1036 will perform an intersect invent on data from merge 1034 which may include dimensionality reduction and/or clustering. Data from intersect 1036 may then be sent to 1042 for news and/or polling embeddings. Data from intersect 1036 may also be sent to 1038 for extract drift and/or stability metrics. Data from 1038 may be sent to 1042 also for news and/or polling embeddings. Data from 1038 may also be sent to 1040 for data for downstream models. This may include high resolution, regional fluctuations in purchase habits and their relationship with the current economical, social, and political climate.

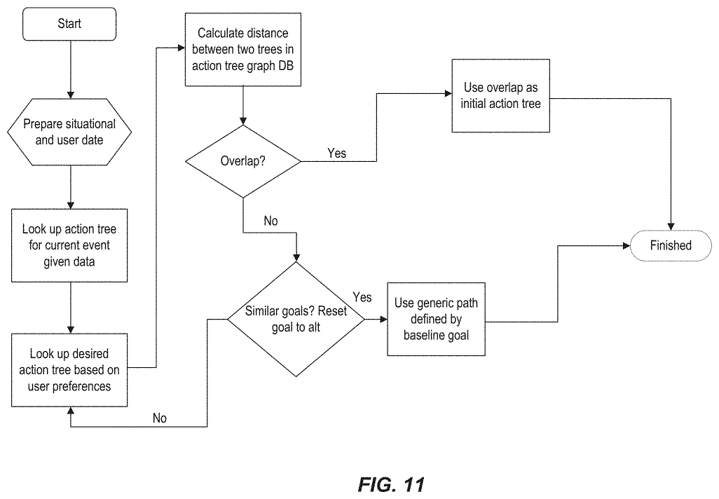

FIG. 11 illustrates an example method of determining a goal and an action tree using artificial intelligence (AI) and/or machine learning (ML). In some embodiments, the method of FIG. 11 may be implemented as a computer-implemented system for providing feedback regarding purchase decisions. For example, the method may prepare situational and user date and loop up an action tree for a current event based on the given data. The system may also look up a desired action tree based on user preferences. In some embodiments, the system may calculate a distance between the action tree for the current event and the desired action tree, for example, using the action tree graph database. If the two action trees overlap, the system may use the overlap as the initial action tree. If the two action trees do not overlap, the system may determine whether the goals are similar. If the goals are similar, the system may use a generic path defined by the baseline goal.

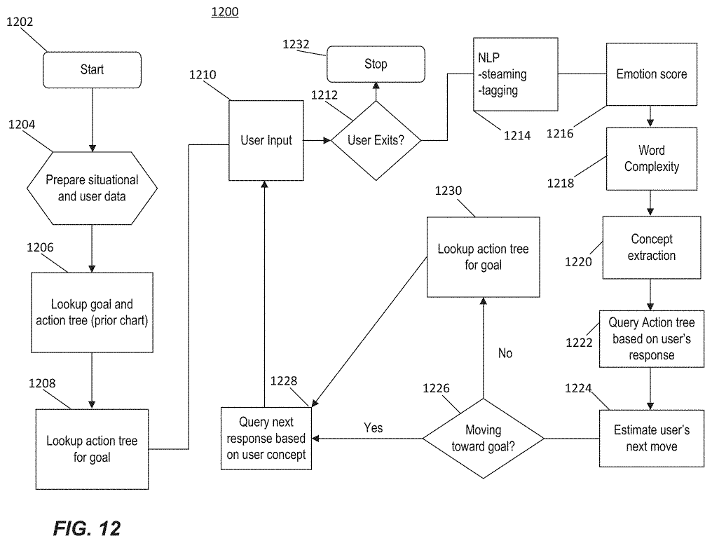

Reference is now made to FIG. 12, which illustrates an example method for performing digital intervention operations, consistent with embodiments of the present disclosure. FIG. 12 shows process 1200 for performing digital intervention operations. Process 1200 may include a step 1202 wherein process 1200 starts.

Process 1200 may also include user input 1210. After start 1202, process 1200 may include a step 1204 wherein situation and user data are prepared. After step 1204, process 1200 may include a step 1206 wherein the goal and action tree (prior chart) are looked up. After step 1206, process 1200 may include a step 1208 wherein action tree for goal is looked up. After step 1208, this information from the previous steps may be sent to user input 1210. Data associated with user input 1210 may be sent to a step 1212 to determine if user exits. If user does not exit, process 1200 may include a step of 1214 wherein NLP is performed which may include steaming and/or tagging. If user does exit, process 1200 may include a step of 1232 wherein process 1200 stops. After step 1214, process 1200 may include a step of 1216 wherein an emotion score is determined. After step 1216, process 1200 may include a step of 1218 wherein word complexity is determined. After step 1218, process 1200 may include a step of 1220 wherein concept extraction is performed. After step 1220, process 1200 may include a step of 1222 wherein query action tree is generated based on user's response. After step 1222, process 1200 may include a step of 1224 wherein an estimation of user's next move is determined. After step 1224, process 1200 may include a step of 1226 wherein a determination is made if user is moving towards goal. If user is not moving towards goal, process 1200 may include a step of 1230 wherein an action tree is looked up to determine goal. If user is moving towards goal, process 1200 may include a step of 1228 wherein a next query response is determined based on user concept. After step 1228, process 1200 may start back again with user input step 1210. After step 1230, process 1200 may include step 1228.

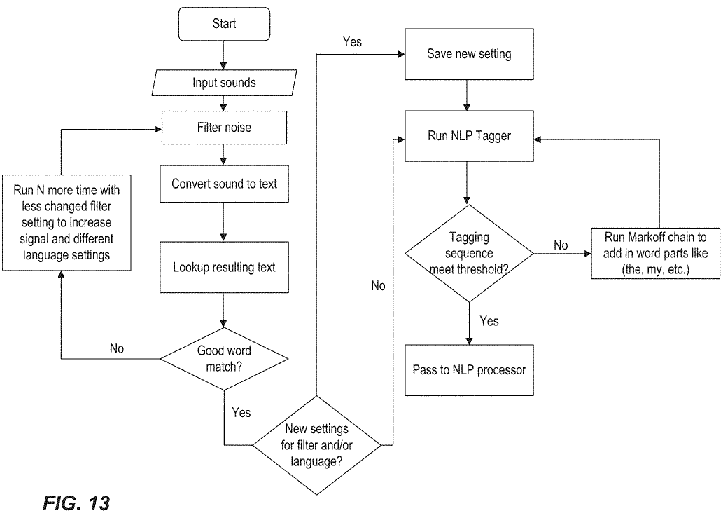

Reference is now made to FIG. 13, which is a diagrammatic representation of a flow for a speech to text engine, consistent with embodiments of the disclosure. A method for transforming speech to text may begin with initiating a “speech to text” function. Sounds or any audio data may be input to the engine. The method may include filtering noise. Input sounds may be converted to text. Next a lookup function may be performed based on the converted text. Next, it may be determined whether there is a match between the converted text and entries in a database (e.g., in a lookup table). If not, the method may return to a preceding step, such as that of filtering noise. A loop may be run a plurality of times (e.g., “n” times) with less changed filter settings to increase signal and test different language settings. If a good match is found, the method may then determine whether new settings for the filter or language should be used.

If new settings should be used, a new setting may be saved. If not, the method may run a natural language processing (NLP) tagger. Upon the tagging sequence meeting a threshold, the method may pass to an NLP processor. If the tagging sequence does not meet the threshold, the method may run Markoff models (e.g., a Markoff chain) to add in word parts (e.g., the, my, etc.).

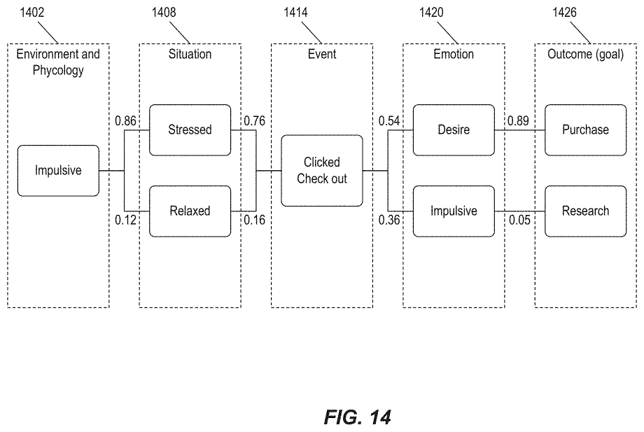

Reference is now made to FIG. 14, which is a diagrammatic representation of an action tree data structure, consistent with embodiments of the present disclosure. The action tree may be segmented into several dimensions, including, e.g., current mood, psychological profiles, goals, current situation, environment, desired path set by user, feasibility of current path. As shown in FIG. 14, an exemplary action tree may include environment and psychology block 1402, situation block 1408, event block 1414, emotion block 1420, and outcome or goal block 1426. Each block may apply edge weightings. For example, there may be an edge weighting of 0.86 for the path from “Impulsive” to “Stressed.” There may be an edge weighting of 0.12 for the path from “Impulsive” to “Relaxed.” Edge weights may reflect probabilities of a next step, or a weighted incident measure.

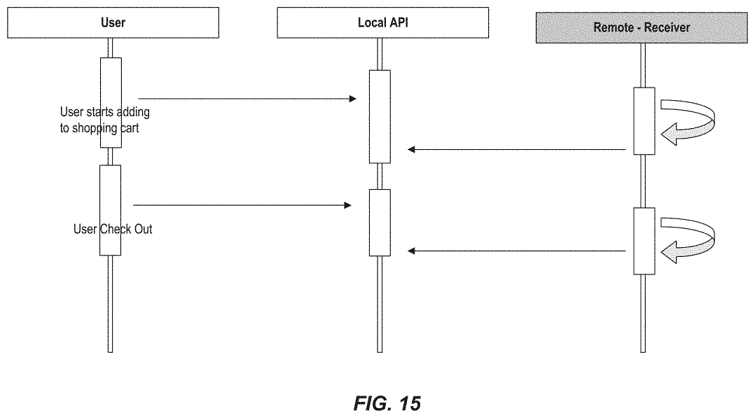

Reference is now made to FIG. 15, which is a diagrammatic representation of a communication protocol for providing digital intervention, consistent with embodiments of the present disclosure. As shown in FIG. 15, an API may monitor user activity to observe drift from predefined goals.

Block diagrams in the figures may illustrate the architecture, functionality, and operation of possible implementations of systems, methods, and computer hardware or software products according to various exemplary embodiments of the present disclosure. In this regard, each block in a schematic diagram may represent certain arithmetical or logical operation processing that may be implemented using hardware such as an electronic circuit. Blocks may also represent a module, segment, or portion of code that comprises one or more executable instructions for implementing the specified logical functions. It should be understood that in some alternative implementations, functions indicated in a block may occur out of the order noted in the figures. For example, two blocks shown in succession may be executed or implemented substantially concurrently, or two blocks may sometimes be executed in reverse order, depending upon the functionality involved. Some blocks may also be omitted. It should also be understood that each block of the block diagrams, and combination of the blocks, may be implemented by special purpose hardware-based systems that perform the specified functions or acts, or by combinations of special purpose hardware and computer instructions.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein.

The embodiments may further be described using the following clauses:
1. A computer-implemented system for providing a digital intervention relating to user interactions, having at least one processor configured to perform operations comprising:
   receiving input data from at least one client device;
   accessing a data model configured to determine, based on historical data, risk levels associated with the user interactions;
   inserting the input data into the data model;
   receiving, from the data model, an indication that at least one determined risk level associated with the user interactions exceeds a preset threshold; and
   providing, in response to the at least one determined risk level exceeding the preset threshold, the digital intervention.
2. The system of clause 1, wherein the at least one processor is configured to further perform:
   analyzing the input data based on a set of predetermined rules.
3. The system of clause 1, wherein the input data includes at least one of: metadata associated with the client device, web browser activity, an API call, IP traffic, a peripheral device input, an electronic activity frequency, or an electronic activity pattern.
4. The system of clause 1, wherein the input data includes at least one indication of a potential online purchase.
5. The system of clause 1, wherein the digital intervention includes instructions configured to inhibit the user interactions.
6. The system of clause 1, wherein the digital intervention includes instructions configured to inhibit access to a webpage.
7. The system of clause 1, wherein the digital intervention includes instructions configured to inhibit entry of user information.
8. The system of clause 1, wherein the digital intervention includes instructions configured to inhibit an API call by manipulating content or structure of the API call.
9. The system of clause 1, wherein the digital intervention includes a two-factor authentication prompt.
10. The system of clause 1, wherein the data model is configured to compute the risk levels.
11. The system of clause 10, wherein the data model is trained to compute the risk levels based on training data sourced from the client device.
12. The system of clause 10, wherein the data model is trained to compute the risk levels based on training data sourced from multiple remote devices.
13. The system of clause 12, wherein the multiple remote devices are associated with a peer group associated with a common trait.
14. The system of clause 12, wherein the training data includes at least one of: web browser activity, an API call, IP traffic, a peripheral device input, an electronic activity frequency, or an electronic activity pattern.
15. The system of clause 1, wherein the data model is configured to generate a suggestion relating to a potential online purchase, and wherein the digital intervention includes a notification containing at least one suggestion relating to the user interactions.
16. The computer-implemented system of clause 15, wherein the notification is provided in a report that is periodically provided to the client device.
17. The system of clause 15, wherein the notification is provided in real-time.
18. The system of clause 15, wherein the notification is provided within a web browser.
19. The system of clause 18, wherein the notification is overlaid over at least a portion of a webpage associated with inputting information for a potential online purchase.
20. The system of clause 15, wherein the notification is provided by a computerized conversational agent.
21. The system of clause 1, wherein the input data includes at least one of: a psychological profile parameter, a demographic trait, a purchase item, a purchase amount, a product category, a merchant identifier, a merchant location, or a device location.
22. The system of clause 1, wherein the operations further comprise deploying the data model to the client device, the data model being configured to run on the client device using at least one of Portable Format for Analytics (PFA) or Predictive Model Markup Language (PMML).
23. A computer-implemented method comprising:
   acquiring client information;
   determining whether to provide a digital intervention based on the client information; and
   providing the digital intervention.
24. A method of training a model, the method comprising:
   providing a parameter input interface to a client device;
   tuning parameters of the model based on input to the parameter input interface.
25. A non-transitory computer readable medium storing a set of instructions that is executable by one or more processors of a user interface system cause a processor of the system to perform a method comprising:
   receiving input data from at least one client device;
   accessing a data model configured to determine, based on historical data, risk levels associated with the user interactions;
   inserting the input data into the data model;
   receiving, from the data model, an indication that at least one determined risk level associated with the user interactions exceeds a preset threshold; and
   providing, in response to the at least one determined risk level exceeding the preset threshold, the digital intervention.
26. A computer-implemented method, comprising:
   receiving input data from at least one client device;
   accessing a data model configured to determine, based on historical data, risk levels associated with the user interactions;
   inserting the input data into the data model;
   receiving, from the data model, an indication that at least one determined risk level associated with the user interactions exceeds a preset threshold; and
   providing, in response to the at least one determined risk level exceeding the preset threshold, the digital intervention.

What is claimed is:

1. A computer-implemented system for providing a digital intervention relating to user interactions, having at least one processor configured to perform operations comprising:
receiving input data from at least one client device;
accessing a data model configured to determine, based on historical data, risk levels associated with the user interactions;
inserting the input data into the data model;
receiving, from the data model, an indication that at least one determined risk level associated with the user interactions exceeds a preset threshold; and
providing, in response to the at least one determined risk level exceeding the preset threshold, the digital intervention.

2. The system of claim 1, wherein the at least one processor is configured to further perform:
analyzing the input data based on a set of predetermined rules.

3. The system of claim 1, wherein the input data includes at least one of:
metadata associated with the client device, web browser activity, an API call, IP traffic, a peripheral device input, an electronic activity frequency, or an electronic activity pattern.

4. The system of claim 1, wherein the input data includes at least one indication of a potential online purchase.

5. The system of claim 1, wherein the digital intervention includes instructions configured to inhibit the user interactions.

6. The system of claim 1, wherein the digital intervention includes instructions configured to inhibit access to a webpage.

7. The system of claim 1, wherein the digital intervention includes instructions configured to inhibit entry of user information.

8. The system of claim 1, wherein the digital intervention includes instructions configured to inhibit an API call by manipulating content or structure of the API call.

9. The system of claim 1, wherein the digital intervention includes a two-factor authentication prompt.

10. The system of claim 1, wherein the data model is configured to compute the risk levels.

11. The system of claim 10, wherein the data model is trained to compute the risk levels based on training data sourced from the client device.

12. The system of claim 10, wherein the data model is trained to compute the risk levels based on training data sourced from multiple remote devices.

13. The system of claim 12, wherein the multiple remote devices are associated with a peer group associated with a common trait.

14. The system of claim 12, wherein the training data includes at least one of:
web browser activity, an API call, IP traffic, a peripheral device input, an electronic activity frequency, or an electronic activity pattern.

15. The system of claim 1, wherein the data model is configured to generate a suggestion relating to a potential online purchase, and wherein the digital intervention includes a notification containing at least one suggestion relating to the user interactions.

16. The computer-implemented system of claim 15, wherein the notification is provided in a report that is periodically provided to the client device.

17. The system of claim 15, wherein the notification is provided in real-time.

18. The system of claim 15, wherein the notification is provided within a web browser.

19. The system of claim 18, wherein the notification is overlaid over at least a portion of a webpage associated with inputting information for a potential online purchase.

20. The system of claim 15, wherein the notification is provided by a computerized conversational agent.

21. The system of claim 1, wherein the input data includes at least one of: a psychological profile parameter, a demographic trait, a purchase item, a purchase amount, a product category, a merchant identifier, a merchant location, or a device location.

22. The system of claim 1, wherein the operations further comprise deploying the data model to the client device, the data model being configured to run on the client device using at least one of Portable Format for Analytics (PFA) or Predictive Model Markup Language (PMML).

23. A computer-implemented method comprising:
receiving input data from at least one client device;
accessing a data model configured to determine, based on historical data, risk levels associated with the user interactions;
inserting the input data into the data model;
receiving, from the data model, an indication that at least one determined risk level associated with the user interactions exceeds a preset threshold; and
providing, in response to the at least one determined risk level exceeding the preset threshold, the digital intervention.

24. A non-transitory computer readable medium storing a set of instructions that is executable by one or more processors of a user interface system cause a processor of the system to perform a method comprising:
receiving input data from at least one client device;
accessing a data model configured to determine, based on historical data, risk levels associated with the user interactions;
inserting the input data into the data model;
receiving, from the data model, an indication that at least one determined risk level associated with the user interactions exceeds a preset threshold; and
providing, in response to the at least one determined risk level exceeding the preset threshold, the digital intervention.
